(19) United States
(12) Patent Application Publication
(10) Pub. No.: US 2026/0193063 A1
(43) Pub. Date: Jul. 9, 2026

(54) CRANE UPPER AND LOWER STRUCTURE INTERLOCKING SYSTEM, AND CRANE

(71) Applicant: XUZHOU HEAVY MACHINERY CO., LTD., Jiangsu (CN)

(72) Inventors: Gengxin REN, Jiangsu (CN); Yong CAO, Jiangsu (CN); Jianguo ZHAO, Jiangsu (CN); Yongbo LI, Jiangsu (CN); Cungang ZHANG, Jiangsu (CN); Zhengxing ZHANG, Jiangsu (CN); Jilong WANG, Jiangsu (CN)

(73) Assignee: XUZHOU HEAVY MACHINERY CO., LTD., Jiangsu (CN)

(21) Appl. No.: 19/558,416

(22) Filed: Mar. 5, 2026

Related U.S. Application Data
(63) Continuation of application No. PCT/CN2024/132144, filed on Nov. 15, 2024.

(30) Foreign Application Priority Data
Jan. 8, 2024 (CN) 202410025586.0

(51) Int. Cl. B66C 13/20; B66C 13/44; B66C 23/80; B66C 23/88; F15B 13/01; F15B 13/044

(52) U.S. Cl. CPC B66C 13/20; B66C 13/44; B66C 23/80; B66C 23/88; F15B 13/01; F15B 13/044

(57) ABSTRACT

Disclosed are a crane upper and lower structure interlocking system, and a crane. In system, a third-stage pump of a hydraulic pump set is connected to an oil inlet of an outrigger extension and retraction valve, and an extension and retraction switching valve in the outrigger extension and retraction valve is connected to the oil inlet of the outrigger extension and retraction valve. A first working oil port and second working oil port of a locking valve are both connected to a fifth working oil port of the extension and retraction switching valve; a third working oil port of the locking valve is connected to a rod cavity of each of a horizontal oil cylinder, a vertical oil cylinder and a fifth outrigger oil cylinder; and a fourth working oil port of the locking valve is connected to a sixth working oil port of the extension and retraction switching valve.

### CROSS-REFERENCE TO RELATED APPLICATION

This application is a continuation of international application of PCT application serial no. PCT/CN2024/132144 filed on Nov. 15, 2024, which claims the priority benefit of China application no. 202410025586.0 filed on Jan. 8, 2024. The entirety of each of the above-mentioned patent applications is hereby incorporated by reference herein and made a part of this specification.

### TECHNICAL FIELD

The present invention relates to the field of construction machinery, and in particular to a crane upper and lower structure interlocking system, and a crane.

### BACKGROUND

At present, electrically controlled outrigger systems are mainly adopted in the prior art. By acquiring upper-structure operation signals and outrigger extension/retraction signals, the energization logic of solenoid valves is controlled to achieve upper and lower structure interlocking. Although the operating principle is simple, the cost is relatively high (approximately five times that of mechanically operated outriggers), making it difficult to meet the increasingly competitive market demands for cranes, particularly the requirements of the series of automotive cranes for the European and American markets recently developed by the applicant, as detailed below:

Chinese Patent Publication No. CN113803309A discloses an energy-saving upper and lower structure interlocking system for an aerial work platform and a control method thereof. In the system, an outlet of a single working pump is connected to an oil inlet of an upper/lower switching valve; an upper-position oil outlet and a lower-position oil outlet of the upper/lower switching valve are respectively connected to an oil inlet of an upper-structure control multi-way valve group and an oil inlet of an outrigger multi-way valve; a main oil circuit of the upper-structure control multi-way valve group is connected in series with an upper-structure solenoid unloading valve; and a common oil return line of lower-structure actuators is connected in series with a normally open outrigger locking valve. A controller achieves energy-saving control of the upper and lower structure interlocking system for an aerial work platform by acquiring signals from a boom return detection switch, an outrigger ground-contact detection switch, and a pressure detection switch at an inlet of the outrigger multi-way valve group. However, this patent mainly suffers from the following problems: when the boom return detection switch detects that the upper-structure boom leaves the boom support frame, if the outrigger control valve is mistakenly operated to extend a vertical cylinder/horizontal cylinder, an oil return line between the outrigger locking valve 7 and a small chamber of the outrigger cylinder will burst due to pressure buildup (a ratio of a large chamber area to a small chamber area of the outrigger cylinder×a main relief valve pressure), posing serious safety risks and failing to achieve true upper and lower structure interlocking. Moreover, during upper-structure operations, although energization of the outrigger locking valve is determined by detecting conduction of a pressure switch, the upper structure remains in a normally operating state, and the outrigger locking valve 7 remains continuously energized, making it impossible to achieve true energy-saving control.

Chinese Patent Publication No. CN110985464A discloses an automatic upper and lower structure interlocking control system for an aerial work platform, and a control method thereof. This solution adopts two sets of normally closed two-position two-way solenoid valves to respectively restrict the upper-structure boom movement and the lower-structure outrigger movement, and additionally uses one upper/lower switching valve to realize manual switching of upper and lower structure flows. Compared with CN113803309A, this solution indeed solves the problem of pipeline bursting when the outrigger control valve is mistakenly operated. However, when the boom return detection switch detects that the upper-structure boom leaves the boom support frame, the operating valve 203 is in a lower position, and the outrigger oil cylinder selection valves 204/205/206/207 are in an upper position, the vertical cylinder 3/horizontal cylinder 5 can extend normally, thus failing to achieve true upper and lower structure interlocking.

Chinese Patent Publication No. CN105288909A discloses an automatic upper and lower structure interlocking device with dual protection for an aerial fire-fighting vehicle. In this solution, an upper-structure portion restricts boom movements by controlling a hydraulic pilot unloading valve group, and a lower-structure portion restricts outrigger movements by using a mechanical interlocking limiting plate and a self-resetting cylinder. In addition, the upper and lower structure interlocking is achieved by driving the upper-structure hydraulic pilot unloading valve and the lower-structure self-resetting cylinder based on the detection results of a position sensor and controller logic calculations. However, this solution has the following problems: the technology is overly complex, has high requirements on machining precision of structural components, and is difficult to assemble. Furthermore, after the upper-structure boom leaves the boom support frame, the lower-structure cylinder must remain continuously energized to lock lower-structure outrigger movements, resulting in significant consumption of battery power.

Chinese Patent Publication No. CN201864543U discloses an outrigger interlocking device for an upper portion of an aerial work platform. This device achieves outrigger interlocking of the upper portion of an aerial work platform by using inductive proximity switches, outrigger interlocking valves, outrigger signal valves, and adapted power supplies, and the like. However, this technical solution has the following problems: when the lower-structure outriggers are not properly deployed or experience outrigger sinking, all lower-structure and upper-structure operations are restricted; however, when the boom support frame is disengaged from the upper structure, retraction of the outriggers is not restricted. As a result, failure to deploy outriggers only locks the upper structure and prevents the boom from moving, but cannot achieve automatic interlocking between upper and lower structures simultaneously, thus posing significant safety hazards.

Chinese Patent Publication No. CN216767964U discloses an automatic interlocking control system for lower structure, upper structure and platform of a bridge inspection vehicle. In this system, three oil outlets of two interlocking solenoid valves are respectively connected to three separate control systems, such that an oil circuit can pass through only one control system at a time, while the other two systems are automatically locked without oil supply. This solution mainly has the following problems: (1) Regardless of which system is operated, at least one solenoid valve is constantly energized. For example, when the telescoping motor 11 is operating, the two-position four-way solenoid valves 2-2 and 2-3 are constantly energized, resulting in high consumption of battery power, and prolonged period of energization causes electromagnets to overheat, easily leading to aging and failure of the electromagnets. (2) To meet different flow and pressure requirements, the valve 2-1 needs to be configured as an electro-proportional relief valve, and the two-position four-way solenoid valves 2-2 and 2-3 need to meet the requirements of maximum flow passage diameter, resulting in high costs. (3) To achieve interlocking of more actions, additional solenoid switching valves need to be connected in series.

In summary, existing boom-type products (with mechanically operated outriggers) cannot achieve upper and lower structure interlocking functions, and face risks of small-chamber pipeline bursting when the vertical cylinder extends. Furthermore, electrically controlled outriggers are far more expensive than mechanically operated outriggers, thus failing to meet requirements.

### SUMMARY

Objectives of the present invention: The present invention aims to provide a crane upper and lower structure interlocking system, and a crane. The solution can achieve unloading of an oil inlet line when misoperation of an outrigger handle occurs during upper-structure operation, thereby realizing a “locking” function against misoperation, effectively reducing a risk of crane overturning caused by mistaken operation of an outrigger multi-way control valve during upper-structure operation, and realizing the upper and lower structure interlocking function.

Technical solutions: The crane upper and lower structure interlocking system provided by the present invention includes a hydraulic pump set, an outrigger extension and retraction valve, horizontal oil cylinders, vertical oil cylinders, and a fifth outrigger oil cylinder, where a third-stage pump of the hydraulic pump set is connected to an oil inlet P of the outrigger extension and retraction valve, an extension and retraction switching valve is disposed in the outrigger extension and retraction valve, and the extension and retraction switching valve is connected to the oil inlet P of the outrigger extension and retraction valve; and a locking valve is connected in series between the extension and retraction switching valve and oil cylinders.

First and second working oil ports of the locking valve are both connected to a fifth working oil port of the extension and retraction switching valve, a third working oil port of the locking valve is connected to rod chambers of the horizontal oil cylinders, the vertical oil cylinders, and the fifth outrigger oil cylinder, and a fourth working oil port of the locking valve is connected to a sixth working oil port of the extension and retraction switching valve.

When a boom is in a non-stowed state, the locking valve is deenergized and operates in a right-hand position; at this moment, regardless of whether the extension and retraction switching valve is in an upper position or a lower position, an oil outlet thereof is directly connected to an oil return port to enable pressure unloading, and the fifth outrigger oil cylinder remains motionless, thereby achieving locking.

Further, the locking valve adopts a normally deenergized control logic.

Further, a solenoid coil of the locking valve is connected to an output terminal of a lower-structure controller, an input terminal of the lower-structure controller is connected to a boom proximity switch, a power take-off detection switch, a pressure detection switch, a vertical outrigger pressure sensor, and a horizontal outrigger length-measurement sensor; and

when the lower-structure controller detects a boom stowing signal, a power take-off switch signal and a pressure detection signal, the lower-structure controller triggers the solenoid coil of the locking valve to be energized.

Further, when the locking valve is energized and the extension and retraction switching valve is in the lower position, hydraulic oil discharged from the third-stage pump of the hydraulic pump set reaches an oil inlet P of the outrigger extension and retraction valve, enters through a port C of the extension and retraction switching valve, exits from an oil outlet d of the extension and retraction switching valve, passes through a port h and a port k of the locking valve, and then passes through a fifth outrigger oil cylinder selection valve and horizontal oil cylinder/vertical oil cylinder selection valves to finally reach rod chambers of outrigger oil cylinders, thereby realizing retraction of the outrigger oil cylinders.

Further, when the locking valve is energized and the extension and retraction switching valve is in the upper position, hydraulic oil discharged from the third-stage pump of the hydraulic pump set reaches the oil inlet P of the extension and retraction switching valve, passes through a port e and a port f to a port j of the extension and retraction switching valve, and then passes through the fifth outrigger oil cylinder selection valve and the horizontal oil cylinder/vertical oil cylinder selection valves to finally reach rodless chambers of the outrigger oil cylinders, thereby realizing extension of the outrigger oil cylinders.

Further, the locking valve adopts an electromechanical integrated control mode, with electrical control as a primary mode and emergency mechanical control as an auxiliary mode.

Further, the crane upper and lower structure interlocking system further includes a pilot control valve, where the pilot control valve is internally provided with a pilot pressure switching valve, a first working oil port of the pilot pressure switching valve is connected to an oil inlet P of the pilot control valve, and a third working oil port of the pilot pressure switching valve is connected to a hydraulic oil tank. A fourth-stage pump of the hydraulic pump set is connected to a second working oil port of the pilot pressure switching valve via a port P4 of a center rotary joint, and the second working oil port of the pilot pressure switching valve is further connected to the hydraulic oil tank via a port T of the center rotary joint.

Further, when the pilot pressure switching valve is energized, the first working oil port of the pilot pressure switching valve is in communication with the third working oil port thereof. Hydraulic oil entering the oil inlet P of the pilot control valve enters the first working oil port of the pilot pressure switching valve and flows into the hydraulic oil tank after flowing out from the third working oil port, in which case pilot oil flows directly back to the hydraulic oil tank through a relief valve inside the pilot control valve.

Further, pressure sensors are mounted on the outrigger oil cylinders. When any one of four outrigger length-measurement signals does not conform to a selected operating condition or any one of four vertical outriggers has abnormal pressure, the lower-structure controller transmits the detected signals to an upper-structure controller via a CAN bus, and the pilot pressure switching valve is energized.

Based on the same inventive concept, the present invention provides a crane, which includes the above-mentioned crane upper and lower structure interlocking system.

### BRIEF DESCRIPTION OF THE DRAWINGS

FIG. 1 is a schematic diagram of a crane upper and lower structure interlocking system according to the present invention.

FIG. 2 is a schematic diagram of a lower-structure locking function when a boom is in a non-stowed state according to the present invention.

FIG. 3 is a schematic diagram illustrating a state in which an extension and retraction control valve is in an upper position when a locking valve is deenergized according to the present invention.

FIG. 4 is a schematic diagram illustrating a state in which an extension and retraction control valve is in a lower position when the locking valve is energized according to the present invention.

FIG. 5 is a schematic diagram illustrating a state in which an extension and retraction control valve is in an upper position when a locking valve is energized according to the present invention.

FIG. 6 is a schematic diagram of an upper-structure locking function in an abnormal outrigger state according to the present invention.

FIG. 7 is a schematic diagram of a control principle of a lower-structure controller according to the present invention.

### DETAILED DESCRIPTIONS OF THE EMBODIMENTS

The technical solution of the present invention is described in detail below with reference to the specific embodiments and the accompanying drawings.

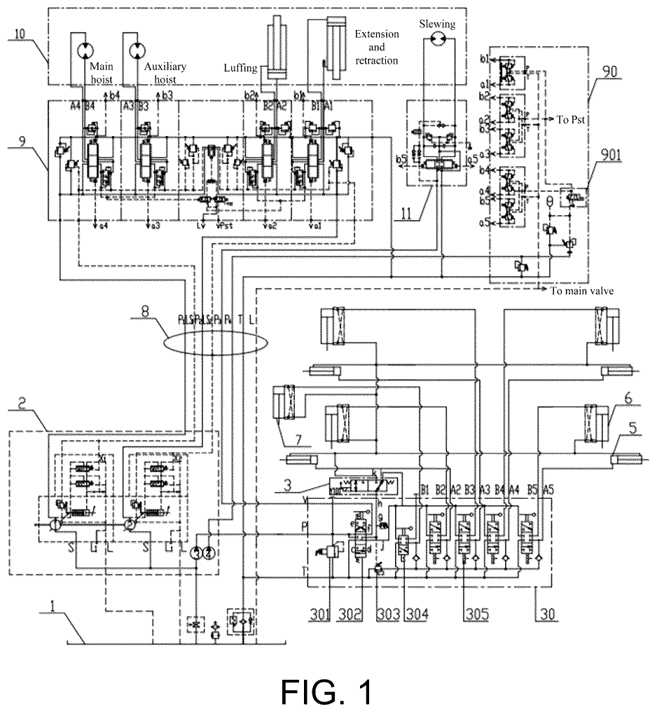

As shown in FIG. 1, a crane upper and lower structure interlocking system provided by the present invention includes the following components: a hydraulic oil tank 1, a hydraulic pump set 2, a locking valve 3, horizontal oil cylinders 5, vertical oil cylinders 6, a fifth outrigger oil cylinder 7, a center rotary joint 8, an upper-structure main control valve 9, an upper-structure actuator 10, a slewing control valve 11, an outrigger extension and retraction valve 30, a main relief valve 301, an extension and retraction switching valve 302, a horizontal oil cylinder extension relief valve 303, a fifth outrigger oil cylinder selection valve 304, horizontal oil cylinder/vertical oil cylinder selection valves 305, a pilot control valve 90, and a pilot pressure switching valve 901, and the like. The specific connection methods among the components are as follows.

The hydraulic oil tank 1 is connected to the hydraulic pump set 2. The hydraulic pump set 2 is composed of a four-stage pump, where a first-stage pump of the hydraulic pump set 2 supplies hydraulic oil to main and auxiliary winches of the upper-structure actuator 10 via the center rotary joint 8 and the upper-structure main control valve 9; a second-stage pump of the hydraulic pump set 2 supplies hydraulic oil for telescoping and luffing of the upper-structure actuator 10 via the center rotary joint 8 and the upper-structure main control valve 9; a fourth-stage pump of the hydraulic pump set 2 supplies hydraulic oil to the pilot control valve 90 via the center rotary joint 8, and the pilot control valve 90 is configured to control directional switching of the upper-structure main control valve 9. During normal operation of the upper structure, the extension and retraction switching valve 302 is in a neutral position, and pressure oil from a third-stage pump of the hydraulic pump set 2 supplies hydraulic oil for upper-structure slewing of the upper-structure actuator 10 via the extension and retraction switching valve 302, the center rotary joint 8, and the slewing control valve 11.

The third-stage pump of the hydraulic pump set 2 is connected to an oil inlet P of the outrigger extension and retraction valve 30. The outrigger extension and retraction valve 30 includes a main relief valve 301, an extension and retraction switching valve 302, a horizontal oil cylinder extension relief valve 303, a fifth outrigger oil cylinder selection valve 304, and horizontal oil cylinder/vertical oil cylinder selection valves 305. The main relief valve 301 is connected between an oil inlet P and a port T of the outrigger extension and retraction valve 30. First and second working oil ports of the extension and retraction switching valve 302 are both connected to the oil inlet P of the outrigger extension and retraction valve 30, a third working oil port of the extension and retraction switching valve 302 is connected to an oil return port T of the outrigger extension and retraction valve 30, a fourth working oil port of the extension and retraction switching valve 302 is connected to the slewing control valve 11 via a V port of the outrigger extension and retraction valve 30 and the center rotary joint 8, a fifth working oil port of the extension and retraction switching valve 302 is connected to first and second working oil ports of the locking valve 3, a sixth working oil port of the extension and retraction switching valve 302 is connected to a fourth working oil port of the locking valve 3, a first working oil port of the fifth outrigger oil cylinder selection valve 304, and first working oil ports of four horizontal oil cylinder/vertical oil cylinder selection valves 305. A second working oil port of the fifth outrigger oil cylinder selection valve 304 and second working oil ports of the horizontal oil cylinder/vertical oil cylinder selection valves 305 are all connected to the oil return port T of the outrigger extension and retraction valve 30. A third working oil port of the fifth outrigger oil cylinder selection valve 304 is connected to a port B1 of the outrigger extension and retraction valve 30, a fourth working oil port of the fifth outrigger oil cylinder selection valve 304 is connected to a rodless chamber of the fifth outrigger oil cylinder 7 and, via a check valve, to the horizontal oil cylinder extension relief valve 303, and the other end of the horizontal oil cylinder extension relief valve 303 is connected to the oil return port T of the outrigger extension and retraction valve 30. A third working oil ports of each horizontal oil cylinder/vertical oil cylinder selection valve 305 is connected to a rodless chamber of each vertical oil cylinder 6, a fourth working oil port of each horizontal oil cylinder/vertical oil cylinder selection valve 305 is connected to a rodless chamber of the horizontal oil cylinder 5 and, via a check valve, to the horizontal oil cylinder extension relief valve 303.

The locking valve 3 is connected in series between the extension and retraction switching valve 302 and oil cylinders. A third working oil port of the locking valve 3 is connected to rod chambers of the horizontal oil cylinder 5, the vertical oil cylinder 6, and the fifth outrigger oil cylinder 7. The locking valve 3 adopts a normally deenergized control logic, thereby effectively solving the problems of heating and aging of electromagnets and battery power loss caused by continuous energization of the locking valve during upper-structure operation, and achieving energy-saving control of the locking valve. A solenoid coil of the locking valve 3 is connected to an output terminal of a lower-structure controller, and an input terminal of a lower-structure controller receives a pressure detection signal, a power take-off signal, and a proximity switch signal mounted on a boom support frame (indicating whether the upper structure is operating). When the lower-structure controller simultaneously detects the pressure signal, the power take-off signal, and a boom stowing signal, the solenoid coil of the locking valve 3 is energized. When a boom rests on the boom support frame, it indicates that the upper structure is not in operation. When the boom is not on the boom support frame, it indicates that the upper structure is operating or about to operate. In this case, when an operator mistakenly actuates an outrigger handle, the outriggers should be locked and prevented from moving.

A locking valve is connected in series between an extension and retraction section, and a selection section of a mechanical outrigger valve. By collecting an upper-structure operation signal, a power take-off signal, and a pressure detection signal, unloading of the oil inlet line is achieved when misoperation of the outrigger handle occurs during upper-structure operation, thereby realizing a “locking” function against misoperation, implementing an upper and lower structure interlocking function in all operating scenarios, and meeting CE certification requirements.

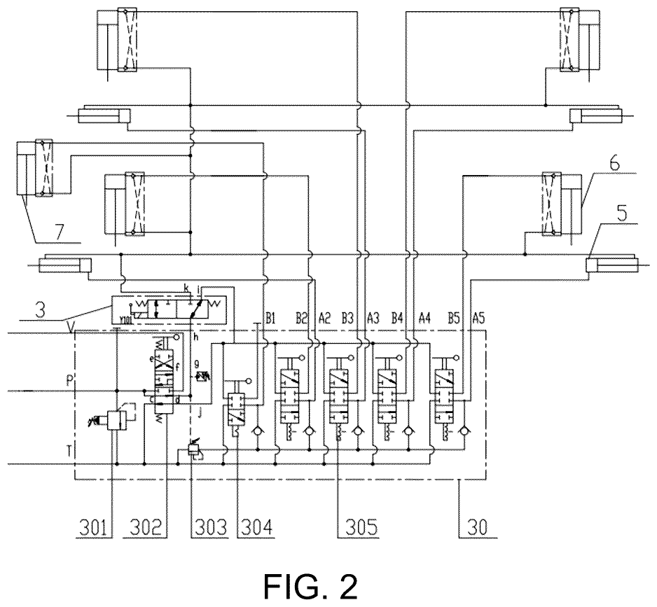

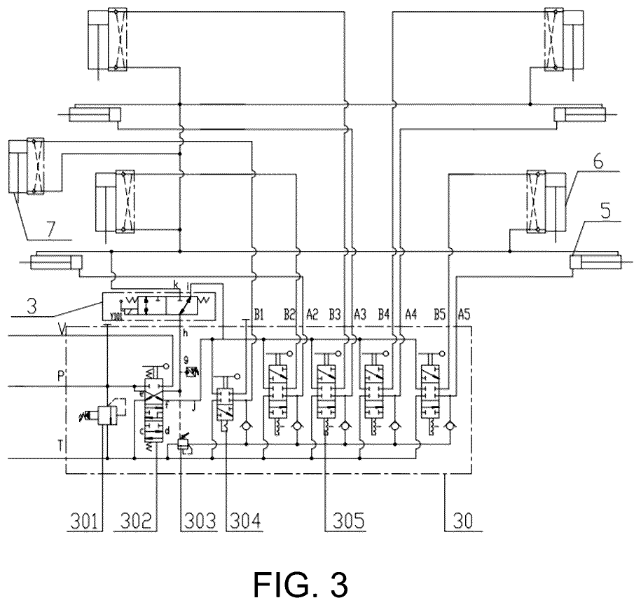

Lower-structure locking function when the boom is in a non-stowed state: When an upper-structure controller detects that the boom is in a non-stowed state, the signal is transmitted to the lower-structure controller, and the locking valve 3 is deenergized and operates in a right-hand position. When the locking valve is deenergized, and the operator mistakenly sets the extension and retraction control valve 302 in a lower position, an oil circuit diagram is shown in FIG. 2; and when the locking valve is deenergized, and the operator mistakenly sets the extension and retraction control valve 302 is in an upper position, an oil circuit diagram is shown in FIG. 3. In this case, when the outrigger extension and retraction valve 30 is mistakenly actuated, regardless of whether the extension and retraction switching valve 302 is in the upper position or the lower position (see FIGS. 2 and 3), an oil outlet of the extension and retraction switching valve 302 is directly connected to an oil return port (the third working oil port) via the locking valve 3, as shown in FIG. 2, thereby realizing pressure unloading. The horizontal oil cylinder 5, the vertical oil cylinder 6, and the fifth outrigger oil cylinder 7 remain motionless, and the outriggers also remain motionless, thereby realizing the lower-structure locking function when the boom is in a non-stowed state. By achieving the “locking” function through pressure unloading during misoperation, difficulties in matching an area ratio between rod chambers and rodless chambers of the outrigger oil cylinders, the main relief pressure setting, and the allowable pressure rating of the pipelines, as well as high risks of pipe bursting, can be effectively resolved.

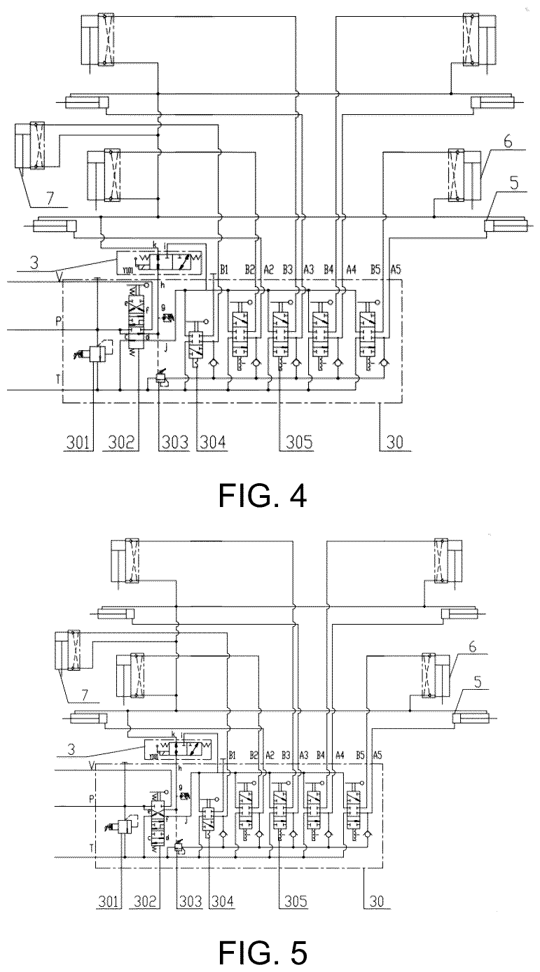

As shown in FIG. 4, when the locking valve 3 is energized and the extension and retraction switching valve 302 is in the lower position, hydraulic oil discharged from the third-stage pump of the hydraulic pump set 2 reaches an oil inlet P of the outrigger extension and retraction valve 30, enters through a port C of the extension and retraction switching valve 302, then exits from a sixth working oil port (an oil outlet d) of the extension and retraction switching valve 302, passes through a port h and a port k of the locking valve 3, and then passes through the fifth outrigger oil cylinder selection valve 304 and the horizontal oil cylinder/vertical oil cylinder selection valves 305 to finally reach rod chambers of outrigger oil cylinders, thereby realizing retraction of the outrigger oil cylinders.

As shown in FIG. 5, when the locking valve 3 is energized and the extension and retraction switching valve 302 is in the upper position, hydraulic oil discharged from the third-stage pump of the hydraulic pump set 2 reaches an oil inlet P of the outrigger extension and retraction valve 302, passes through a port e and a port f to a port j of the extension and retraction switching valve 302, and then passes through the fifth outrigger oil cylinder selection valve 304 and the horizontal oil cylinder/vertical oil cylinder selection valves 305 to reach rodless chambers of the outrigger oil cylinders, thereby realizing extension of the outrigger oil cylinders.

Normal outrigger extension and retraction state: Compared with the upper-structure operating time, a proportion of time during which the outriggers are extended and retracted is very small (less than 1%). Therefore, the locking valve 3 remains in a normally deenergized state during upper-structure operation. In addition, to avoid unnecessary battery power consumption of a chassis caused by long-term energization of the locking valve during operation of the crane, energy-saving control of the valve group is achieved. The energization triggering conditions of the locking valve 3 must satisfy the following three requirements: (1) the power take-off signal is detected; (2) a boom stowing signal is detected; and (3) the pressure detection signal is detected. When the locking valve 3 is energized and the extension and retraction switching valve 302 is in the lower position (see FIG. 4), pressure oil from the third-stage pump flows through the extension and retraction switching valve 302, the horizontal oil cylinder/vertical oil cylinder selection valves and the fifth outrigger oil cylinder selection valve, thereby realizing extension of the outrigger oil cylinders. When the extension and retraction switching valve 302 is in the upper position, it is in an outrigger oil cylinder retraction section, and hydraulic oil enters a common return chamber of the outrigger oil cylinders through the oil inlet P and completes the retraction of the oil cylinders through the outrigger oil cylinder selection section, as shown in FIG. 5 for details, thereby realizing normal extension and retraction of the outriggers.

As shown in FIG. 1, the pilot control valve 90 is internally provided with a pilot pressure switching valve 901, a first working oil port of the pilot pressure switching valve 901 is connected to an oil inlet P of the pilot control valve 90, and a third working oil port of the pilot pressure switching valve 901 is connected to a hydraulic oil tank 1. A fourth-stage pump of the hydraulic pump set 2 is connected to a second working oil port of the pilot pressure switching valve 901 via a port P4 of the center rotary joint 8, and the second working oil port of the pilot pressure switching valve 901 is further connected to the hydraulic oil tank 1 via a port T of the center rotary joint 8.

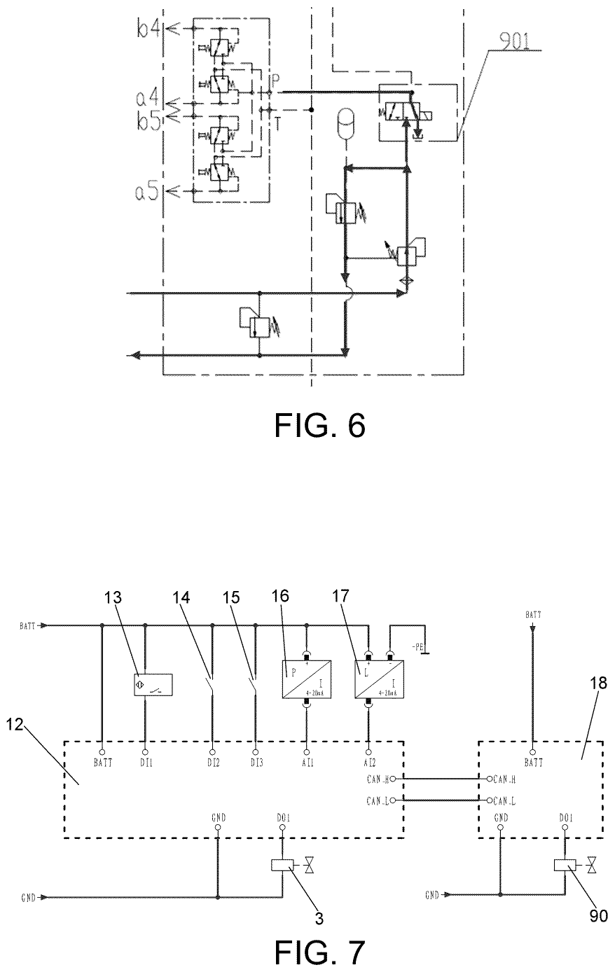

As shown in FIG. 6, when the pilot pressure switching valve 901 is energized, the first working oil port of the pilot pressure switching valve 901 is in communication with the third working oil port thereof. Hydraulic oil entering the oil inlet P of the pilot control valve 90 enters the first working oil port of the pilot pressure switching valve 901 and flows out from the third working oil port, and then flows into the hydraulic oil tank 1, in which case pilot oil flows directly back to the hydraulic oil tank 1 through a relief valve inside the pilot control valve 90.

Upper-structure locking function in an abnormal outrigger state: When the lower-structure controller detects that any one of four outrigger length-measurement signals does not conform to a selected operating condition or that pressure of any one of four vertical outriggers has abnormal pressure, the lower-structure controller transmits the detected signals to the upper-structure controller via a CAN bus, and the pilot pressure switching valve 901 is energized, in which case the pilot oil flows directly back to the hydraulic oil tank 1 through the relief valve, and the upper-structure main control valve 9 cannot be shifted, thereby realizing the upper-structure locking function in the abnormal outrigger state. After the action is limited, it may be released by using a master override switch of a force limiter outside the operator cab. Length-measurement sensors are arranged on the outriggers and are mounted on movable outriggers. Pressure sensors are mounted on the outrigger oil cylinders.

Chassis initial adjustment/locking valve solenoid fault status: During initial adjustment of the chassis, since the upper-structure boom has not yet been installed, a boom stowing signal cannot be detected. Alternatively, when a solenoid of the locking valve malfunctions, the outriggers cannot be extended or retracted, affecting subsequent operation of the crane. The locking valve 3 adopts an electromechanical integrated control mode, with electrical control as a primary mode and emergency mechanical control as an auxiliary mode, thereby improving maneuverability during operation.

As shown in FIG. 7, an input terminal of the lower-structure controller 12 is connected to a boom proximity switch 13, a power take-off detection switch 14, a pressure detection switch 15, a vertical outrigger pressure sensor 16, and a horizontal outrigger length-measurement sensor 17, respectively, which are configured to detect whether the boom is in a stowed state, signal, whether the crane PTO is engaged, whether the operator is actuating the outrigger valve, whether the vertical outriggers are unloaded, and whether the horizontal outriggers show an extension and retraction tendency, respectively. The pressure detection switch 15 is installed at a position g shown in FIGS. 2 and 3. Since the pressure detection switch is installed at this position, once a handle of the extension and retraction control section is actuated, indicating an intention to operate the outriggers, the pressure detection switch closes after a pressure is detected. An output terminal of the lower-structure controller 12 is connected to the locking valve 3. An output terminal of the upper-structure controller 18 is connected to the pilot control valve 90. When the lower-structure controller 12 detects a boom stowing signal (the boom rests on the boom support frame, and the proximity switch is installed on the boom support frame), a power take-off switch signal (to avoid erroneous energization of the locking valve during operation of the crane), and a pressure detection signal (at a position g in the drawings, indicating that the operator has operated an outrigger handle), the lower-structure controller 12 controls the locking valve 3 to be energized, in which case extension and retraction of the outriggers are normal. When the above signals are not detected, the locking valve is deenergized. In this case, when the operator mistakenly operates the outrigger handle, the outriggers cannot be extended or retracted, thereby achieving a locking effect. During upper-structure operation, the pilot pressure switching valve 901 must be energized, and energization of the pilot pressure switching valve 901 indicates upper-structure operation. During operation, when the upper-structure controller 18 detects an abnormality in any of the vertical outrigger pressure sensor/horizontal outrigger length-measurement sensor, the upper-structure controller 18 controls the pilot control valve 90 to be deenergized. When the pilot control valve 90 is deenergized, operating valves of the upper structure (extension and retraction, luffing, main and auxiliary winches, and slewing) cannot be shifted, thereby realizing locking of upper-structure actions.

In the technical solution of the present invention, when misoperation of the outrigger handle occurs during upper-structure operation, an oil inlet line of the outrigger extension and retraction system is directly connected to an oil return line through the locking valve, thereby unloading the oil inlet line during misoperation and achieving a “locking” function against misoperation, thereby achieving the upper and lower structure interlocking function in all operating scenarios. The system is simple, reliable and low-cost. By collecting the power take-off switch signal, the boom stowing signal, and the pressure detection signal, energy-saving control of the locking valve is achieved, ensuring that the locking valve remains deenergized during upper-structure operation and crane operation, thereby effectively solving risks of electromagnet heating and aging and battery power depletion caused by continuous energization of the locking valve. The locking valve is not limited to electromechanical integrated control or hydraulic control. Any improvements and modifications for realizing the functions of the two-position four-way locking valve fall within the scope of protection of the present invention.

The technical solution of the present invention is used to solve contradictions in existing boom-type products (mechanical outrigger operation) in which upper and lower structure interlocking cannot be realized and electrically controlled outrigger operation has high cost. The present invention further realizes energy-saving control of the upper and lower vehicle interlocking function, thereby greatly improving safety, reliability, energy efficiency, and economy of the system.

The present invention further provides a crane, where the crane adopts the above-mentioned upper and lower structure interlocking system, thereby effectively reducing a risk of crane overturning caused by mistaken operation of an outrigger multi-way control valve during upper-structure operation and realizing the upper and lower structure interlocking function.

Beneficial effects: Compared with the prior art, the technical solutions of the present invention have the following beneficial effects:
(1) By connecting a novel locking valve in series with the original mechanical outrigger valve, the outrigger hydraulic system effectively reduces the risk of crane overturning caused by mistaken operation of an outrigger multi-way control valve during upper-structure operation, and realizes the upper and lower structure interlocking function, significantly improving the overall safety of the crane during operation.
(2) Compared with the methods that provide the upper and lower structure interlocking function through electronically controlled outrigger systems, the system of the present invention significantly reduces cost and improves system reliability.
(3) By collecting the power take-off switch signal and the upper-structure operating signal, energy-saving control of the locking valve is achieved, ensuring that the locking valve remains deenergized during upper-structure operation and crane operation, thereby effectively solving risks of electromagnet heating and aging and battery power depletion caused by continuous energization of the locking valve.

What is claimed is:

1. A crane upper and lower structure interlocking system, comprising a hydraulic pump set, an outrigger extension and retraction valve, horizontal oil cylinders, vertical oil cylinders, and a fifth outrigger oil cylinder; wherein a third-stage pump of the hydraulic pump set is connected to an oil inlet P of the outrigger extension and retraction valve, an extension and retraction switching valve is disposed in the outrigger extension and retraction valve, and the extension and retraction switching valve is connected to the oil inlet P of the outrigger extension and retraction valve; and a locking valve is connected in series between the extension and retraction switching valve and oil cylinders;
first working oil port and second working oil port of the locking valve are both connected to a fifth working oil port of the extension and retraction switching valve, a third working oil port of the locking valve is connected to rod chambers of the horizontal oil cylinders, the vertical oil cylinders, and the fifth outrigger oil cylinder, and a fourth working oil port of the locking valve is connected to a sixth working oil port of the extension and retraction switching valve; and
when a boom is in a non-stowed state, the locking valve is deenergized and operates in a right-hand position; at this moment, regardless of whether the extension and retraction switching valve is in an upper position or a lower position, an oil outlet of the extension and retraction switching valve is directly connected to an oil return port via the locking valve, to enable pressure unloading, and the horizontal oil cylinders, the vertical oil cylinders, the fifth outrigger oil cylinder remain motionless, thereby achieving locking.

2. The crane upper and lower structure interlocking system according to claim 1, wherein the locking valve adopts a normally deenergized control logic.

3. The crane upper and lower structure interlocking system according to claim 1, wherein a solenoid coil of the locking valve is connected to an output terminal of a lower-structure controller, an input terminal of the lower-structure controller is connected to a boom proximity switch, a power take-off detection switch, a pressure detection switch, a vertical outrigger pressure sensor, and a horizontal outrigger length-measurement sensor; and
when the lower-structure controller detects a boom stowing signal, a power take-off switch signal and a pressure detection signal, the lower-structure controller energizes the solenoid coil of the locking valve.

4. The crane upper and lower structure interlocking system according to claim 3, wherein when the locking valve is energized and the extension and retraction switching valve is in the lower position, hydraulic oil discharged from the third-stage pump of the hydraulic pump set reaches the oil inlet P of the outrigger extension and retraction valve, enters through a port C of the extension and retraction switching valve, then exits from the oil outlet d of the extension and retraction switching valve, passes through a port h and a port k of the locking valve, and then passes through the fifth outrigger oil cylinder selection valve and horizontal oil cylinder/vertical oil cylinder selection valves to reach rod chambers of outrigger oil cylinders, thereby realizing retraction of the outrigger oil cylinders.

5. The crane upper and lower structure interlocking system according to claim 3, wherein when the locking valve is energized and the extension and retraction switching valve is in the upper position, hydraulic oil discharged from the third-stage pump of the hydraulic pump set reaches the oil inlet P of the extension and retraction switching valve, passes through a port e and a port f to a port j of the extension and retraction switching valve, and then passes through fifth outrigger oil cylinder selection valve and horizontal oil cylinder/vertical oil cylinder selection valves to reach rodless chambers of outrigger oil cylinders, thereby realizing extension of the outrigger oil cylinders.

6. The crane upper and lower structure interlocking system according to claim 1, wherein the locking valve adopts an electromechanical integrated control mode, with electrical control as a primary mode and emergency mechanical control as an auxiliary mode.

7. The crane upper and lower structure interlocking system according to claim 1, further comprising a pilot control valve, wherein the pilot control valve is internally provided with a pilot pressure switching valve, a first working oil port of the pilot pressure switching valve is connected to an oil inlet P of the pilot control valve, and a third working oil port of the pilot pressure switching valve is connected to a hydraulic oil tank; a fourth-stage pump of the hydraulic pump set is connected to a second working oil port of the pilot pressure switching valve via a port P4 of a center rotary joint, and the second working oil port of the pilot pressure switching valve is further connected to the hydraulic oil tank via a port T of the center rotary joint.

8. The crane upper and lower structure interlocking system according to claim 7, wherein when the pilot pressure switching valve is energized, the first working oil port of the pilot pressure switching valve is in communication with the third working oil port of the pilot pressure switching valve thereof; and hydraulic oil entering via the oil inlet P of the pilot control valve enters the first working oil port of the pilot pressure switching valve and then flows into the hydraulic oil tank after flowing out from the third working oil port of the pilot pressure switching valve; and pilot oil flows directly back to the hydraulic oil tank through a relief valve inside the pilot control valve.

9. The crane upper and lower structure interlocking system according to claim 7, wherein pressure sensors are mounted on outrigger oil cylinders; when any one of four outrigger length-measurement signals does not conform to a selected operating condition or any one of four vertical outriggers has abnormal pressure, the lower-structure controller transmits the detected signals to an upper-structure controller via a CAN bus, and the upper-structure controller controls the pilot pressure switching valve to be energized.

10. A crane, comprising the crane upper and lower structure interlocking system according to claim 1.

11. A crane, comprising the crane upper and lower structure interlocking system according to claim 2.

12. A crane, comprising the crane upper and lower structure interlocking system according to claim 3.

13. A crane, comprising the crane upper and lower structure interlocking system according to claim 4.

14. A crane, comprising the crane upper and lower structure interlocking system according to claim 5.

15. A crane, comprising the crane upper and lower structure interlocking system according to claim 6.

16. A crane, comprising the crane upper and lower structure interlocking system according to claim 7.

17. A crane, comprising the crane upper and lower structure interlocking system according to claim 8.

18. A crane, comprising the crane upper and lower structure interlocking system according to claim 9.
